(19) United States
(12) Patent Application Publication
(10) Pub. No.: US 2010/0188751 A1
(43) Pub. Date: Jul. 29, 2010

(54) OPTICAL FILMS WITH INTERNALLY CONFORMABLE LAYERS AND METHOD OF MAKING THE FILMS

(75) Inventors: Graham M. Clarke, Woodbury, MN (US); Brian W. Lueck, Houlton, WI (US); Raymond P. Johnston, Lake Elmo, MN (US); Paul E. Humpal, Stillwater, MN (US); Dale L. Ehnes, Cotati, CA (US); Timothy J. Hebrink, Scandia, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/632,247

(22) Filed: Dec. 7, 2009

Related U.S. Application Data
(60) Provisional application No. 61/148,235, filed on Jan. 29, 2009.

(51) Int. Cl. G02B 5/02; B29D 11/00; G02B 5/22

(52) U.S. Cl. 359/599; 264/1.7; 359/361

(57) ABSTRACT

A co-extrusion method for making a replicated film. The method includes the steps of providing at least three materials and co-extruding them between a nip roll and a structured roll. The materials include a backside layer material, a core layer material, and a replicated layer material. The structured roll has a surface structure that is replicated onto the replicated layer, and the core layer is an internally conformable layer that conforms with the replicated layer.

### REFERENCE TO RELATED APPLICATION

The present application claims priority to U.S. Provisional Patent Application Ser. No. 61/148,235 and filed Jan. 29, 2009, which is incorporated herein by reference as if fully set forth.

### BACKGROUND

Polymer co-extrusion is a common technology and is utilized in many polymer film applications, such as optical films for use in active display devices, static display devices such as graphic signs, solid state lighting, and the like. The co-extrusion process uses a structured roll in order to impart structure into one surface of the film during the co-extrusion process. However, it can be difficult to obtain desired replication fidelity, meaning that the structure on the film does not adequately correspond with the structure on the roll. Also, co-extrusion processes to make optical films typically use expensive polymer materials, increasing the cost of the resulting film.

Accordingly, a need exists for an improved co-extrusion process to make films and for improved replicated films, such as optical films.

### SUMMARY

A co-extrusion method for making an optical film, consistent with the present invention, includes the steps of providing at least two materials and co-extruding them between a nip roll and a structured roll. The optical film comprises a core layer material and a replicated layer material. The structured roll has a surface structure that is replicated onto the replicated layer, and the core layer is an internally conformable layer that conforms with the replicated layer. The film can optionally include a backside layer material adjacent the core layer on a side opposite the replicated layer. The backside layer can optionally possess a replicated surface structure.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for co-extrusion creating an internally conformable layer;

FIG. 2 is a side view of a replicated film construction;

FIG. 3 is a side view of a replicated film construction with rounded peaks on the replicated layer and sharp peaks on the core layer;

FIG. 4 is a side view of a replicated film construction with rounded peaks on both the replicated and core layers; and

FIG. 5 is a side view of a replicated film construction with rounded peaks on both the replicated and core layers, and with a more internally conformal layer than the construction shown in FIG. 4; and

FIG. 6 is a top view of a tool pattern with an offset.

### DETAILED DESCRIPTION

Embodiments of the present invention relate to a film article and an associated co-extrusion process to make the film in which the internal or core layer of the film conforms to the replicated structure on one or both outer surfaces of the film. The internal structure is automatically aligned with the external replicated structure and may affect the optical or other characteristics of the film compared to a film in which the internal layers are substantially parallel to the plane of the film. By varying the materials, processing parameters, and replicated structure, the co-extrusion process can be used to create tunable optical properties for a range of films and improve the performance of the films. For example, the index of refraction of the core polymer or the depth of penetration of the core layer into the external structure can be varied.

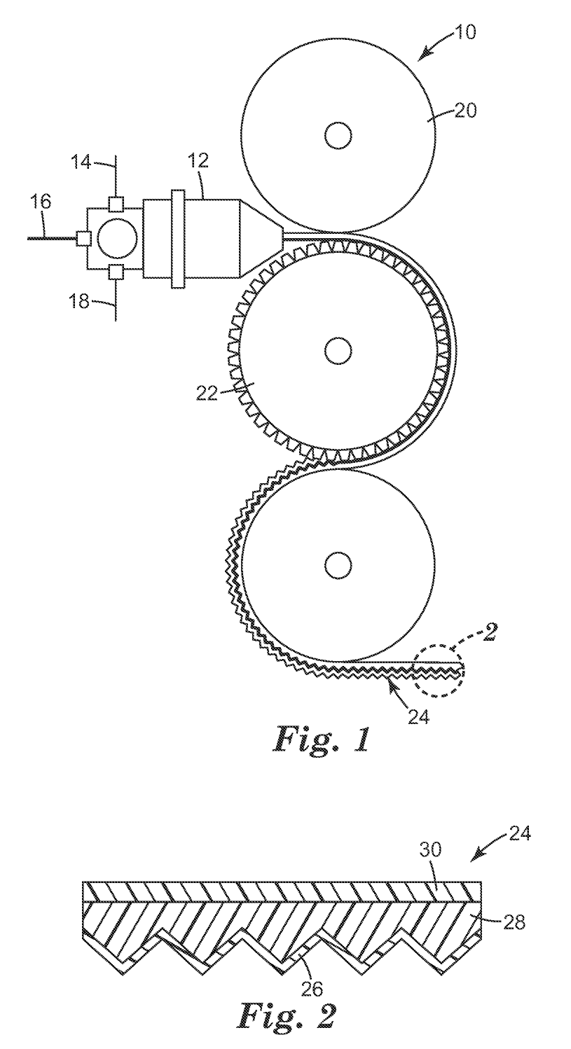

FIG. 1 is a diagram of a system 10 for co-extrusion creating an internally conformable layer. System 10 includes an extrusion die 12 for receiving a backside layer material 14, a core layer material 16, and a replicated layer material 18. The extrusion die 12 co-extrudes the three materials between a nip roll 20 and a structured roll 22, creating a film 24. Any number of co-extruded layers could be used, which can provide certain advantages such as graduated optical or physical properties within the film. An apparatus for performing co-extrusion is described in U.S. Pat. No. 6,767,492, which is incorporated herein by reference as if fully set forth.

FIG. 2 is a side view of a construction of replicated film 24 formed from the co-extrusion process. Film 24 includes a backside layer 30, a replicated layer 26, and an internally conformable core layer 28. Replicated layer 26 is created by structured roll 22 and has internal and external structured surfaces replicated from the structure on roll 22. The process of creating replicated layer 26 also creates the internally conformable layer 28, which conforms to the backside of replicated layer 26. Therefore, nip roll 20 and structured roll 22 are positioned such that the structure is both replicated in replicated layer 26 and creates internally conformable layer 28 for the core layer. Use of the internally conformable layer results in better replication fidelity of the replicated layer 26 and also results in more volume of the core layer and less volume of the replicated layer, typically providing for lower cost as the material for the replicated layer can cost more than the material for the core layer. By using appropriate resins, the internally conformable layer also provides for improved thermal stability of the film and can provide for better resistance to damage of the replicated layer by forming a more rigid internal supporting structure for the replicated layer. Therefore, these replicated films with at least one internally conformable layer have more rigidity, improved abrasion resistance, and decreased cracking.

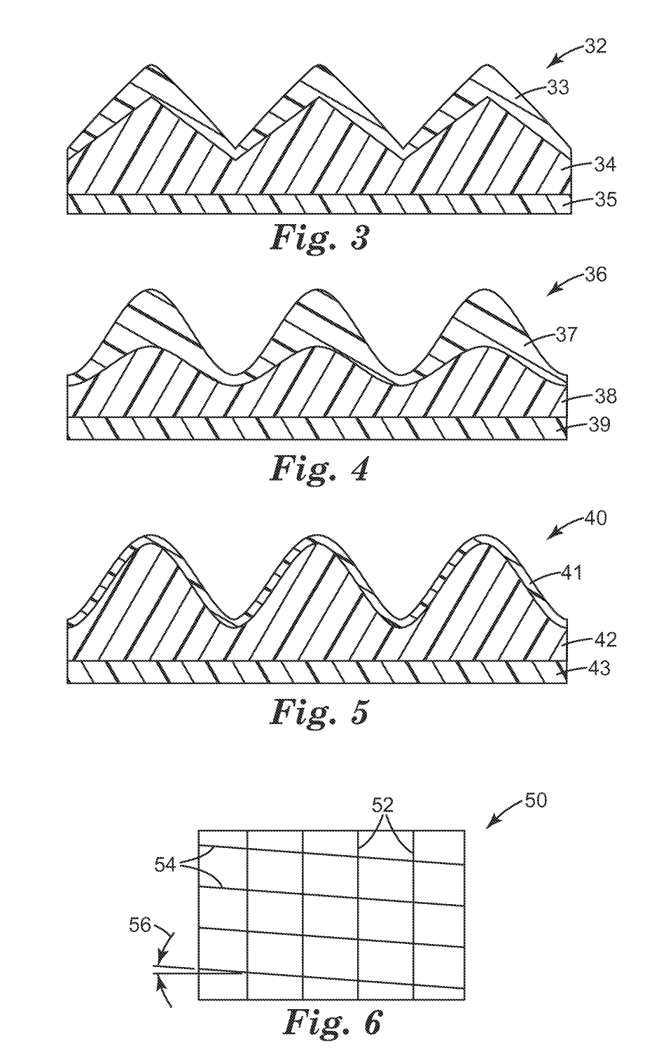

FIGS. 3-5 are side views of examples of other replicated films 32, 36, and 40, respectively. Film 32 includes a backside layer 35, a core layer 34 with sharp peaks, and a replicated layer 33 with rounded peaks on its exterior surface. Film 36 includes a backside layer 39, a core layer 38 with rounded peaks, and a replicated layer 37 with rounded peaks on its exterior surface. Film 40 includes a backside layer 43, and also includes a core layer 42 a replicated layer 41 each having rounded peaks, except that core layer 42 is more internally conformal with replicated layer 41 compared with the conformal construction of core layer 38 in film 36. Due to these possible variations in the conformability of the core layer, for example, a layer other than the replicated layer can have a structure with a different geometry to the replicated layer. In addition to the combination of structures shown in films 32, 36, and 40, the core and replicated layers can each independently have sharp or rounded peaks. Films 32, 36, and 40 can be made using the process described above.

Depending upon the tooling structure, the backside, replicated, and core layers can contain a variety of replicated patterns or structure. For example, the layers can contain prisms, grooves, intersecting prisms or grooves, optical microlenses, or other discrete microstructures. Any of these exemplary features can form optical microstructures. These features can be ordered, random, or pseudo-random in nature. Any of the layers can have one or more additional coatings or additives such as the following: a UV absorber; a UV stabilizer; a static dissipative additive; or an optical enhancer. Also, the external surfaces of the film can have a matte surface created by subtractive, additive, or displacement processes applied to the tooling rolls. Fixed abrasive media processing, electro-deposition of surface topography, or loose media impact (bead blasting) are respective examples of these three processes.

The ratio of the thickness of the replicated layer to the height of the replicated structure determines the extent to which the internally conformable core layer conforms to the replicated layer. A replicated layer with a thickness such that the structured portion of the film consists almost entirely of the replicated layer will produce a film with the internally conformable layer being essentially planar. A thin replicated layer will create an internal core layer which extends extensively into the film structure and conforms more closely with the structure.

It is generally advantageous for the co-extruded film to be symmetrical about its mid-plane such that the backside layer and replicated layer are of the same material and approximately the same thickness. This symmetry balances the internal stresses, or reduces unbalanced stresses, in the final film thereby reducing curling, and it also aids in extrusion of the film from the die. A film having different materials for the backside and replicated layers may be advantageous when additives such as UV absorbers, antistatics, colorants and others are to be added, or when a subsequent process is to be applied such as adding an adhesive coating to the backside layer.

The various layers of the film 24 can be indexed matched. Tailored properties can be achieved by selecting to which layer performance enhancing additives can be added. Also, backside layer 30 can include a UV absorber, and replicated layer 26 can include an anti-static material or coating. Alternatively, other layers can include the UV absorber or anti-static material or coating. Other coatings can also be applied to the film. The backside layer can alternatively be designed to function as a matte diffuser. The backside layer can also be formed as a strippable skin layer. A protective premask can be added to either side or both exterior surfaces of the film. The materials for the various layers are preferably transparent or substantially transparent for use of the replicated film as an optical film for a display device. For example, the replicated films are particularly suitable for use as a gain diffuser.

Polymers that can be used as the replicated layer include the following: styrene acrylonitrile copolymers; styrene(meth)acrylate copolymers; polymethylmethacrylate; polycarbonate; styrene maleic anhydride copolymers; nucleated semi-crystalline polyesters; copolymers of polyethylenenaphthalate; polyimides; polyimide copolymers; polyetherimide; polystyrenes; syndiodactic polystyrene; polyphenylene oxides; cyclic olefin polymers; and copolymers of acrylonitrile, butadiene, and styrene. One preferable polymer is the Lustran SAN Sparkle material available from Ineos ABS (USA) Corporation.

Polymers for the core layer include but are not limited to polycarbonate, poly-methylmethacrylate, and poly-acrylonitrile-butadiene styrene. These polymers are chosen primarily for their high flexural modulus, thermal stability, and relative low cost compared to some polymers. One preferable polymer is the Makrolon polycarbonate material available from Bayer Corporation.

Polymers that can be used for the backside layer include the following: polycarbonates; polyesters; blends of polycarbonates and polyesters; copolymers of styrene; copolymers of acrylonitrile, butadiene, and styrene; block copolymers of styrene with alkene-polymerized midblocks; acid and anhydride functionalized polyolefins; and copolymers of polyethylene and polypropylene

FIG. 6 is a top view of a tool pattern with an offset. Roll 50 contains a surface structure such as, for example, linear prisms, crossed prisms, lenslets, microlenses, or other structures, any of which can be discrete or interconnected. Roll 50 corresponds with structured roll 22 and contains, in this example, structure in two directions. In particular, roll 50 includes a first structure 52 in a down web position and a second structure 54 in a cross web direction. Structures 52 and 54 may comprise grooves, for example, or any other surface structure protruding from or indenting into a surface of roll 50. The cross web structure 54, in this example, includes an offset at an angle 56 from the axis of roll 50. The offset angle is preferably approximately 10° and more preferably approximately 15° from the roll axis. The offset allows the co-extruded material to more easily fill the structured roll pattern in the co-extrusion process, resulting in better replication fidelity in the film. In this example, structure 52 in the down web direction is made in roll 50 using a fast tool servo, and structure 54 in the cross web direction is made in roll 50 using synchronous flycutting. A method for making a tool have structure in two directions is described in U.S. patent application Ser. No. 12/362,048, entitled “Method for Making an Optical Film Having a Variable Prismatic Structured Surface,” and filed on Jan. 29, 2009, which is incorporated herein by reference as if fully set forth.

### Examples

### Example 1

A 10 inch wide three-manifold extrusion die (manufactured by Extrusion Dies, Inc) was used to extrude a three-layer film into a nip between a nip roll and a structured tooling roll. The structured tooling roll had as its structure linear grooves oriented around the circumference of the roll. These grooves had a 90° included angle and a pitch of approximately 356 microns for a groove depth of approximately 178 microns. Applying nip pressure between the nip roll and tooling roll created the structured film. The structured tooling toll was created using conventional diamond turning with the structure in only a single down web direction.

Table 1 provides the film construction and Table 2 provides co-extrusion process parameters for this example.

TABLE 1
Film Construction

| | | Caliper |
|---|---|---|
| Layer | Material | (approximate) |
| replicated | Ineos Corp. SAN Sparkle resin | 0.003 inch |
| core | Bayer Polycarbonate 2407 | 0.011 inch |
| backside | Ineos Corp. SAN Sparkle resin | 0.003 inch |

TABLE 2
Process Parameters

| Parameter | Value | |
|---|---|---|
| line speed | 20 | feet per minute (fpm) |
| nip pressure | 375 | pounds per linear inch (pli) |
| tool roll temperature | 160° | F. |
| nip roll temperature | 60° | F. |

In this example, the core layer structure was shown to closely conform to the tooling structure. In particular, the film was shown to have sharp peaks of the internal core layer compared to more rounded external peaks of the replicated layer. The use of a strippable layer as the replicated layer, and its subsequent removal from such a three-layer construction, can enable sharp pointed features to be formed without the complete filling of the tooling structure.

### Example 2

A feedblock was used to feed three polymer layers to a 36 inch wide die. This co-extruded film was extruded directly into a nip between a structured pattern roll and a smooth metal nip roll and subsequently around a strip-off roll prior to winding. All three rolls were temperature controlled using water. Nip pressure applied to the extrudate between the nip roll and tooling roll creating the structured pattern in the film.

The channels in the tool were approximately triangular in cross-section with a depth of 60 microns and a pitch (groove to groove spacing) of approximately 114 microns. The cross-direction grooves were aligned at a 10° bias angle to the down web grooves. The tooling roll pattern was created as described in U.S. patent application Ser. No. 12/362,048, entitled “Method for Making an Optical Film Having a Variable Prismatic Structured Surface,” and filed on Jan. 29, 2009.

Table 3 provides the film construction and Table 4 provides co-extrusion process parameters for this example.

TABLE 3
Film Construction

| | | Caliper |
|---|---|---|
| Layer | Material | (approximate) |
| replicated | Ineos Corp. SAN Sparkle resin | 0.003 inch |
| core | Bayer Polycarbonate 2407 | 0.011 inch |
| backside | Ineos Corp. SAN Sparkle resin | 0.003 inch |

TABLE 4
Process Parameters

| Parameter | Value | |
|---|---|---|
| line speed | 50 | fpm |
| nip pressure | 340 | pli |
| tool roll temperature | 160° | F. |
| nip roll temperature | 60° | F. |

In this example, the core layer extended approximately one-third the height of the structure creating rounded peaks of the internal core layer.

1. A co-extrusion method for making a film, comprising:
providing to an extrusion die a backside layer material, a core layer material, and a replicated layer material; and
co-extruding the backside layer material, the core layer material, and the replicated layer material between a nip roll and a structured roll to create a film having a backside layer, a core layer, and a replicated layer, wherein the structured roll has a surface structure that is replicated onto the replicated layer, and wherein the core layer is an internally conformable layer that conforms with the replicated layer.

2. The method of claim 1, wherein the surface structure comprises grooves.

3. The method of claim 2, wherein the grooves are arranged in a down web position and a cross web position on the structured roll.

4. The method of claim 3, wherein the grooves in the cross web direction have an offset with respect to an axis of the structured roll.

5. The method of claim 4, wherein the offset is approximately 10°.

6. The method of claim 4, wherein the offset is approximately 15°.

7. The method of claim 1, wherein at least one of the backside layer, the core layer, and the replicated layer comprise at least one or more of the following additives: a UV absorber; a UV stabilizer; a static dissipative additive; or an optical enhancer.

8. The method of claim 1, wherein the core layer material comprises polycarbonate.

9. The method of claim 1, wherein the core layer comprises more than one layer.

10. The method of claim 1, wherein the core layer material, the backside layer material, and the replicated layer material are transparent.

11. The method of claim 1, wherein the backside layer is a matte diffuser.

12. The method of claim 1, wherein the replicated layer is a strippable skin layer.

13. The method of claim 1, wherein a layer other than the replicated layer has a structure with a different geometry to the replicated layer.

14. The method of claim 1, wherein the replicated layer has an external peak and the core layer has an internal peak sharper than the external peak.

15. A film, comprising:
a first layer having a first surface; and
a second layer having a second surface and a first interface between the first layer and the second layer,
wherein the first interface is conformal to the first surface and the second surface, the first surface comprises an optical microstructure, and the first surface and the second surface have a replicated pattern.

16. The film of claim 15, further comprising a third layer adjacent the second layer opposite the second surface.

17. The film of claim 15, wherein second surface comprises a matte surface.

18. The film of claim 15, wherein the second surface comprises an optical microstructure.

19. The film of claim 16, wherein at least one of the first, second, or third layers contains at least one of the following additives: a UV absorber; a UV stabilizers; a static dissipative additive; or an optical enhancer.

20. The film of claim 15, wherein the first layer is a strippable skin.

21. The film of claim 15, wherein at least one of the first and second surfaces contain a coating.

22. The film of claim 15, wherein the first surface contains replicated grooves.

23. The film of claim 15, wherein the first surface contains replicated intersecting grooves.

24. The film of claim 15, wherein the first surface contains microlenses.

25. The film of claim 15, wherein the second surface contains a matte microstructure created by bead blasting.

26. The film of claim 15, wherein the first surface contains replicated intersecting grooves with a groove to groove spacing of 114 microns.

27. The film of claim 15, wherein at least one exterior surface of the film has a protective premask attached to it.

28. A film, comprising:
a replicated layer having a first surface;
a core layer having a second surface and a first interface between the replicated layer and the core layer; and
and a backside layer adjacent the core layer opposite the second surface,
wherein the first interface is conformal to the first surface and the second surface, the first surface comprises an optical microstructure, and the first surface and the second surface have a replicated pattern

29. The film of claim 28, wherein the backside layer has a matte coating.
